(19) United States
(12) Patent Application Publication
(10) Pub. No.: US 2013/0122534 A1
(43) Pub. Date: May 16, 2013

(54) Microfluidic Assay

(71) Applicants: Chwee Teck Lim, Singapore (SG); Eric Lim, London (GB); Andee Tay, London (GB)

(72) Inventors: Chwee Teck Lim, Singapore (SG); Eric Lim, London (GB); Andee Tay, London (GB)

(21) Appl. No.: 13/664,526

(22) Filed: Oct. 31, 2012

Related U.S. Application Data
(60) Provisional application No. 61/554,004, filed on Nov. 1, 2011.

(51) Int. Cl. G01N 1/30

(52) U.S. Cl. CPC G01N 1/30
USPC 435/29

(57) ABSTRACT

A process for carrying out hematoxylin and eosin staining in a microfluidic device is described.

### FIELD

This invention relates to process for carrying out hematoxylin and eosin staining in a microfluidic device.

### BACKGROUND

The detection of circulating tumour cells (CTC) present in the bloodstream of patients with cancer provides a means for characterisation and monitoring of cancers. A microfluidic device has been developed which allows the isolation of CTCs by taking advantage of the fact that CTCs have different physical properties to other blood constituents (Tan, S. J. et al, Biosensors and Bioelectronics 26 (2010) 1701-1705 and Tan, S. J. et al, Biomed Microdevices 11(4):883-892, 2009).

This microfluidic device (also referred to as a CTChip) is able to isolate CTCs in a label-free manner, with no need for biomarkers. Separation of CTCs in the device utilizes the fact that the size and stiffness of cancer cells are larger than that of blood cells. The device comprises a microfluidic channel through which a blood sample is flowed. Within the channel is an array of multiple cell isolation wells, each well being made up of a three projections (isolation structures) in a crescent shaped configuration and separated from each other by a gap of 5 μm. The size of this gap ensures the flow through of blood constituents due to their deformability and ability to traverse small constrictions. CTCs which are less deformable are trapped in the cell isolation wells.

A problem with CTC work is that cancer cells are identified by a combination of antibody markers (e.g. Ep CAM+ve, CD 45−e, DAPI+ve), yet this is not how cancer is defined by World Health Organisation criteria. In clinical practice, cancer is defined by hematoxylin and eosin appearance, supplemented when necessary with antibody markers.

Hematoxylin and eosin staining is the most widely used cell staining technique in medical diagnosis. Standard hematoxylin and eosin staining protocols are carried out by fixing cells on a slide using a formalin fixative and then sequentially applying hematoxylin and eosin stain solutions.

It has been observed that it is not possible to successfully carry out hematoxylin and eosin staining on a microfluidic device as described above using conventional staining protocols because undesired precipitation occurs during the staining process. It is therefore desirable to provide an optimised hematoxylin and eosin staining protocol that can be used to stain cells in a microfluidic device as described above without inducing undesired precipitation in the device.

### SUMMARY

Accordingly, in a first aspect of the invention there is provided a process for carrying out hematoxylin and eosin staining of circulating tumour cells trapped in a microfluidic device, the device comprising a sample inlet and at least one outlet connected in fluid communication by a microfluidic channel, the microfluidic channel having a plurality of cell isolation wells positioned therein, each well comprising an array of isolation structures arranged to trap a circulating tumour cell, but allow passage of other blood constituents, wherein the process comprises the steps of:
(a) flowing a blood sample through the channel and allowing trapping of circulating tumour cells by the isolation structures to occur;
(b) washing by flowing a liquid through the channel;
(c) flowing a fixative solution through the channel, wherein the fixative solution comprises paraformaldehyde and methanol;
(d) washing by flowing a liquid through the channel to remove excess fixative;
(e) staining with hematoxylin solution;
(f) washing by flowing a liquid through the channel; and
(g) staining with eosin solution.

The process may further comprise the step (a′), prior to step (a), of priming the microfluidic device by flowing a priming solution through the channel. Accordingly, the process may comprise the steps of:
(a′) priming the microfluidic device by flowing a priming solution through the channel;
(a) flowing a blood sample through the channel and allowing trapping of circulating tumour cells by the isolation structure to occur;
(b) washing by flowing a liquid through the channel;
(c) flowing a fixative solution through the channel, wherein the fixative solution comprises paraformaldehyde and methanol;
(d) washing by flowing a liquid through the channel to remove excess fixative;
(e) staining with hematoxylin solution;
(f) washing by flowing a liquid through the channel; and
(g) staining with eosin solution.

It has been determined that the combination of fixative reagents used in the above process, preferably in combination with the priming reagents described herein, enables hematoxylin and eosin staining to be successfully carried out in a microfluidic device without stain precipitation occurring.

The priming solution may be an aqueous EDTA solution, preferably at a concentration of 8-12 mM. The priming solution may be an 8-12 mM EDTA solution in phosphate buffered saline (PBS). Preferably, the priming solution is an EDTA/PBS solution at a concentration of about 10 mM.

The fixative solution may be an aqueous solution of paraformaldehyde and methanol. The solution may be in water or an aqueous buffer solution as a solvent. The solvent is preferably phosphate buffered saline (PBS). The fixative solution may be a 3-5 w/v % paraformaldehyde solution (e.g. in PBS), containing 15-25 v/v % methanol. Preferably, the fixative solution is a 4 w/v % paraformaldehyde solution in PBS, containing 20 v/v % methanol. Methanol is incorporated for membrane permeabilisation and avoids the need for treatment with a surfactant such as Triton X-100. Accordingly, steps (c) and (d), and preferably the entire process, of the invention may be carried out in the absence of surfactants such as Triton X-100.

Staining is carried out by exposing fixed cells to hematoxylin solution, washing, then subsequently exposing the cells to eosin solution. The hematoxylin staining may be carried out for up to 15 minutes. Preferably, hematoxylin staining is carried out for 1-5 minutes, more preferably for about 3 minutes. The hematoxylin solution is preferably a Harris's hematoxylin solution.

The eosin solution is preferably a 0.5% (w/v) eosin-Y solution (preferably an aqueous solution) diluted to a ratio of about 1:5 in deionised water to give a working concentration of 0.1%.

A final washing step (step (h)) may be carried out subsequent to eosin staining, by flowing a liquid through the channel. In general, washing steps may be carried out using water or an aqueous solution. In the process described above, washing steps (d), (f) and (h) are preferably carried out by washing with water or a buffered aqueous solution (such as PBS), preferably deionised water. Washing step (b) may preferably be carried out using the priming solution, as described above.

### BRIEF DESCRIPTION OF THE DRAWINGS

Specific embodiments of the invention are described below by way of example only and with reference to the accompanying drawings, in which:

FIG. 1 shows a schematic view of a microfluidic device in which a process of the invention may be performed, wherein (a) is a photograph of the microfluidic device; (b) illustrates the isolation well dimensions and (c) is a plan view showing a detailed layout of the microfluidic device.

### DESCRIPTION

In the context of this disclosure, a microfluidic device is a device comprising at least one channel having at least one dimension of less than 1 mm.

In the context used herein, ‘about’ is taken to encompass a variation of ±10% of any value to which it refers.

Hematoxylin and eosin staining steps are carried out by flowing hematoxylin and eosin stain solutions, respectively, into the channel thereby exposing trapped cells to stain solutions in situ.

As mentioned above, in a device in which the process of the first aspect of the invention is performed, each cell isolation well comprises an array of isolation structures. These structures are projections extending into the channel, preferably from the channel floor. Each well preferably comprises 3 or more (preferably 3) isolation structures arranged in a curved array (preferably crescent-shaped), with a gap of about 4-6 μm, preferably about 5 μm between the structures forming the well. Preferably, the cell isolations wells are positioned with a spacing of about 40-60 μm, preferably about 50 μm.

It will be appreciated that the process of the invention could also be used to perform hematoxylin and eosin staining of cells in a microfluidic device of varying structure and/or to stain varying cell types. Accordingly, in a further aspect the invention provides a process of carrying out hematoxylin and eosin staining of cells trapped in a microfluidic device, the process comprising the process steps as described above in respect of the first aspect of the invention. The microfluidic device may optionally have the structure defined in respect of the first aspect of the invention.

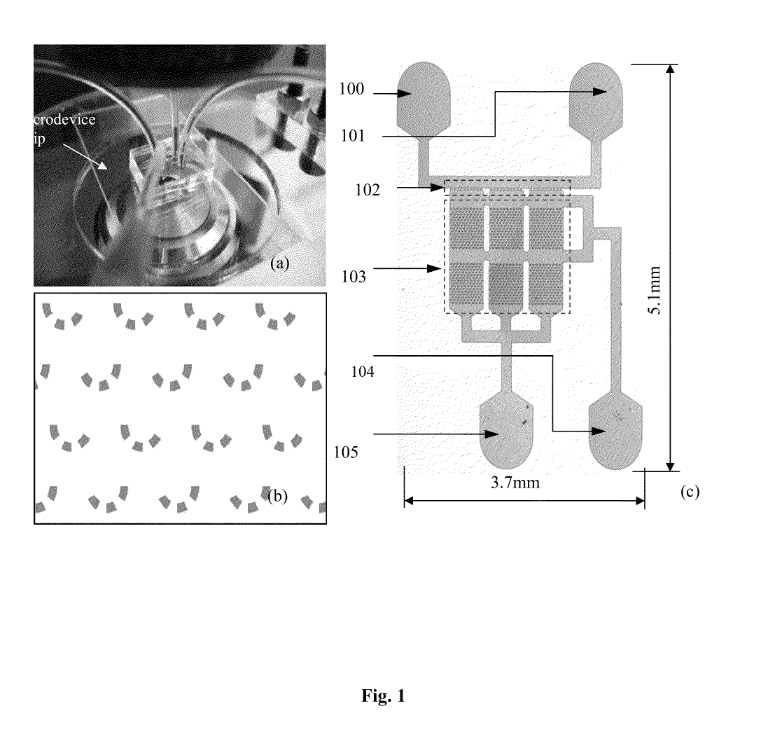

A microfluidic device within which the staining protocol of the invention can be carried out is illustrated in FIGS. 1(a), (b) and (c). The device comprises a sample inlet 100, first and second waste outlets 101, 105 linked in fluid communication by a microfluidic channel system within which are located a pre-filter 102 and a plurality of cell isolation wells 103. Details of this device are disclosed in Tan, S. J. et al, Biosensors and Bioelectronics 26 (2010) 1701-1705 and Tan, S. J. et al, Biomed Microdevices 11(4):883-892, 2009, the disclosures of which are incorporated herein by reference. In operation, a blood sample is flowed through the device from the sample inlet and through the array of cell isolation wells 103, where trapping of CTCs, separating them from the remainder of blood constituents, occurs. Separation of CTCs in the device utilizes the fact that the size and stiffness of cancer cells are larger than that of blood cells. Each of the plurality of cell isolations wells 103 is made up of an array of three projections (isolation structures) in a crescent shaped configuration and separated from each other by a gap of 5 μm (FIG. 1(b)). The size of this gap ensures the flow through of blood constituents due to their deformability and ability to traverse small constrictions. CTCs which are less deformable are trapped in the cell isolation wells. The cell isolation wells are positioned with a spacing of 50 μm apart, which prevents cells clogging in the device. The pre filter 102 has gaps of 20 μm, prevents debris within a blood sample from clogging the device and, by connection to the waste outlet 101, enables removal of debris. A cell collection point 104 is also present.

Once CTCs are trapped within the device, staining of the cells can be performed in-situ using the staining protocol described herein, to identify the different cancer cells present.

An exemplary staining protocol which has been carried out on a device as described above (referred to as the CTChip) and has successfully achieved hematoxylin and eosin staining without precipitation is as follows:

The set-up is housed in a laminar flow hood and all fluids are filtered through a membrane (pore size=0.22 μm) before injection into the CTChip to minimize the introduction of debris into system, which adversely affects CTC isolation and staining

### I. CTChip Priming

1. Three Tygon tubings are cut and attached to a tubing connection assembly such as a Luer Lock connector.
2. Each tubing is carefully inserted into one of three ports in the CTChip.
3. The tubings are then attached, via the tubing connection, to three reservoir barrels set-up on a stand. Each of the three ports in the CTChip now corresponds to an individual barrel.
4. 2 ml of 10 mM EDTA/PBS is filtered and injected into the barrels connected to both the blood and secondary ports.
5. The manifold, which is connected to a syringe pump that controls the pressure through the CTChip, is set to the ‘priming’ configuration.
6. The CTChip is primed once it is entirely filled with 10 mM EDTA/PBS and no air bubbles are present in the traps or ports. This is determined visually, via a camera.

### II. CTC Isolation

7. Fresh blood is collected in EDTA-containing blood collection tubes, kept at 4° C. and processed within 24 hours of collection.
8. The manifold and pump are set to the ‘isolation’ configuration. Negative pressure through the waste port causes fluid to flow from the blood and secondary port, through the chip and out through the waste port.
9. Flow through the secondary port is stopped by closing the secondary tubing with a tubing clamp.
10. The blood is filtered through a 40 μm cell strainer to remove clots and 1 ml is injected into the blood port.
11. Once the blood enters the chip, it takes about 2 hours for 1 ml of blood to be filtered through the traps and end up in the waste barrel.

### III. Washing and Fixing

12. After 1 ml of blood has been processed, the secondary tubing is released and the blood tubing is closed, also via a tubing clamp. This stops the flow of blood through the chip and washes 10 mM EDTA/PBS through the traps.
13. After 15 minutes, any 10 mM EDTA/PBS remaining in the secondary barrel is removed.
14. A 4% paraformaldehyde fixative containing 20% methanol is prepared. 500 μl of this solution is filtered and injected into the secondary barrel.
15. After 20 minutes, any remaining fixative is removed from the secondary barrel and replaced with 500 μl of deionised water.

### IV. Staining

16. After 15 minutes of washing, the deionised water is replaced by 500 μl of Harris's hematoxylin (e.g. from Leica Microsystems).
17. Hematoxylin staining carries on for 3 minutes and is followed by another 15 minute wash with deionised water.
18. Subsequently, the water is removed and replaced by a 0.5% aqueous eosin-Y solution (diluted 1:5).
19. After 15 minutes, a final wash with deionised water is carried out.
20. The CTChip and its trapped cells are then ready to be observed under higher magnification.

The protocol set out above was successful in enabling hematoxylin and eosin staining to be carried out without undesired precipitation.

The fixative solution can be prepared according to the following process: 1) Dissolve 4 g PFA in 100 ml 0.01M PBS, heat and stir mixture on a stirring block until all the PFA is dissolved; 2) To make 1 ml of 20% methanol in 4% PFA, add 200 μl of 100% methanol to 800 μl of the 4% PFA solution made in step 1; 3) Filter before use.

Experimental work was carried out to determine the effect of varying a number of the process steps in the protocol described above. In this work, the following was determined.

The concentration of the priming solution was found to be important. In the protocol above, a 10 mM EDTA/PBS priming solution is utilised and gives good results. However, decreasing this concentration to 5 mM EDTA/PBS produced undesirable streaky precipitation in the device prior to introduction of blood, as did use of an acid-citrate-dextrose solution.

The timing of hematoxylin staining in step 17 was also found to be important. A lower duration of hematoxylin staining, was found to give the best results, avoiding overstaining which can obscure cellular content.

In addition, a dilution of the eosin solution to a ratio of about 1:5 in deionised water, to give a working concentration of 0.1%, was found to be optimal in avoiding stain precipitation.

Whilst specific components have been described above as making up the embodiments described above, it is envisaged that, even when not explicitly stated above, alternative components may be substituted therefore, where those alternative components are substantially functionally equivalent to those described above. In the embodiments set forth below, and of the recited embodiments can be combined with any of the previously described embodiments. That is, where a particular claim is dependent upon another claim, it should be understood that the present disclosure includes such claim also being dependent upon any other previously recited claim.

What is claimed is:

1. A process for carrying out hematoxylin and eosin staining of circulating tumour cells trapped in a microfluidic device, the device comprising a sample inlet and at least one outlet connected in fluid communication by a microfluidic channel, the microfluidic channel having a plurality of cell isolation wells positioned therein, each well comprising an array of isolation structures arranged to trap a circulating tumour cell, but allow passage of other blood constituents, wherein the process comprises:
(a) flowing a blood sample through the channel and allowing trapping of circulating tumour cells by the isolation structure to occur;
(b) washing by flowing a liquid through the channel;
(c) flowing a fixative solution through the channel, wherein the fixative solution comprises paraformaldehyde and methanol;
(d) washing by flowing a liquid through the channel to remove excess fixative; and
(e) staining with hematoxylin solution;
(f) washing by flowing a liquid through the channel and
(g) staining with eosin solution.

2. The process of claim 1, comprising step (a′), prior to step (a), of priming the microfluidic device by flowing a priming solution through the channel.

3. The process of claim 2, wherein the priming solution is an EDTA solution.

4. The process of claim 3, wherein the priming solution is an 8-12 mM EDTA solution.

5. The process of claim 4, wherein the priming solution is an 8-12 mM EDTA solution in PBS.

6. The process of claim 3, wherein the EDTA priming solution has an EDTA concentration of about 10 mM.

7. The process of claim 1, wherein the fixative solution is a solution of paraformaldehyde and methanol in a solvent.

8. The process of claim 7, wherein the fixative solution is a solution in phosphate buffered saline (PBS).

9. The process of claim 7, wherein the fixative solution is a 3-5 w/v % paraformaldehyde solution, containing 15-25 v/v % methanol.

10. The process of claim 9, wherein the fixative solution is a 4 w/v % paraformaldehyde solution, containing 20 v/v % methanol.

11. The process of claim 1, wherein step (f) comprises staining with hematoxylin for 1-5 minutes.

12. The process of claim 1, wherein the eosin solution used in step (h) is an aqueous eosin-Y solution with a concentration of about 0.1% (w/v).

13. The process of claim 2, wherein the liquid used in washing step (c) is the same as the priming solution.

14. A process of carrying out hematoxylin and eosin staining of cells trapped in a microfluidic device, the process comprising process steps (a) to (g), and optionally (a′), as defined in claim 1.
